(19) United States
(12) Patent Application Publication
(10) Pub. No.: US 2012/0279924 A1
(43) Pub. Date: Nov. 8, 2012

(54) METHOD FOR MITIGATING EUTROPHICATION IN A WATER BODY

(75) Inventors: Jiang-Jin LIN, Taichung City (TW); Shu-Chi Chang, Taichung City (TW); Chen-Hao Li, Kaohsiung City (TW); Yu-Han Yu, Taipei City (TW)

(73) Assignee: NATIONAL CHUNG-HSING UNIVERSITY, Taichung City (TW)

(21) Appl. No.: 13/293,318

(22) Filed: Nov. 10, 2011

(30) Foreign Application Priority Data
May 6, 2011 (TW) 100115986

(51) Int. Cl. C02F 1/28; B82Y 30/00

(52) U.S. Cl. 210/660; 977/776; 977/755

(57) ABSTRACT

A method for mitigating eutrophication in a water body includes: adding a treating agent that contains nanosilicate platelets to an eutrophic water body, such that algae and suspended substances in the eutrophic water body are adsorbed by the nanosilicate platelets.

### CROSS-REFERENCE TO RELATED APPLICATION

This application claims priority of Taiwanese application no. 100115986, filed on May 6, 2011.

### BACKGROUND OF THE INVENTION

1. Field of the Invention

This invention relates to a method for mitigating eutrophication in a water body, more particularly to a method for mitigating eutrophication in a water body using nanosilicate platelets.

2. Description of the Related Art

Eutrophication occurs when a water body (such as ocean, lake, river, or water reservoir) is rich in nutrient salts (for example, nitrates and phosphates). It promotes excessive growth of algae, such as Microcystis sp., Cyanobacteria, Chlorella sp., Peridinium, Golden alga, Cylindrospermopsis raciborskii, Anabaena circinalis, Oscillatoria, Raphidiopsis, etc. Some of the above-mentioned algae release toxins and thus might harm human beings, and the algae may block sunlight and seriously reduce the dissolved oxygen content in the water body that could cause death of aquatic organisms.

Especially, when eutrophication occurs in a water reservoir, it results in a relatively high loading for a water purifying plant to treat water from the water reservoir. For example, in a coagulation sedimentation process, the amount of a coagulant will be increased. In a filtering process of the water purifying treatment, the filter is likely to be clogged with the algae to reduce the water discharge amount of the filter, and thus, it is necessary to increase the backwash times for the filter, thereby increasing water consumption. In a chlorine treating process, the cells of the algae will be destroyed by chlorine to release toxins and disinfection byproducts (DBPs) that are toxic and carcinogenic substances and that increase the risk to human health. Besides, the algae residues that are not removed by the water purifying treatment may deposit in water distribution pipes. The deposited algae are likely to be decomposed to release toxins and organics (such as ammonia) in water distribution pipes, thereby reducing the amount of residual chlorine and adversely affecting water quality.

In order to remove the algae in the water body, several techniques have been proposed.

### A. Physical Process

(1) Aeration, which is used to increase the dissolved oxygen content of lower strata of the water body, and to reduce formation of the organics.

(2) Agitation of the water body, which may bring the algae to the lower strata of the water body and cause death of the algae.

(3) Discharge of the middle and lower strata of the water body, which is used to reduce amount of the nutrient salts.

(4) Installation of artificial floating islands, which are used to block sunlight to decrease photosynthesis efficiency of the algae.

### B. Chemical Process

(1) Addition of algaecide (such as copper sulfate, potassium permanganate, chlorine dioxide, ozone, etc.), which can rapidly kill the algae and oxidize the toxins released from the algae.

(2) Addition of a plant extract (such as extracts of barley, rice, Typha orientalis Presl, Ceratophyllum demersum, Eleocharis dulcis, Potamogetonoctandrus Poir, Limnophila trichophylla (Komarov), etc.), which is used to inhibit the growth of the algae.

### C. Biological Process

(1) Breeding fish to eat the algae, examples of the fish including Grass silver carp, Aristichthysnobilis, etc.

(2) Culturing plants to inhibit the growth of the algae, examples of the plants including Phragmites, Eichhornia crassipes, water caltrop, etc.

(3) Constructed wetland to remove organic pollutant flowing into the water body.

### SUMMARY OF THE INVENTION

Therefore, an object of the present invention is to provide a method for mitigating eutrophication in a water body that can simply, rapidly and efficiently kill algae and reduce turbidity of the water body.

Accordingly, a method for mitigating eutrophication in a water body comprises: adding a treating agent that contains nanosilicate platelets to an eutrophic water body, such that algae and suspended substances in the eutrophic water body are adsorbed by the nanosilicate platelets.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a plot illustrating concentration variations of algae cells in an eutrophic water body with time, the eutrophic water body being treated with a treating agent of NSS1150 containing different dosages of nanosilicate platelets;

FIG. 2 is a plot illustrating survival ratio variations of algae cells in the eutrophic water body with time, the eutrophic water body being treated with the treating agent of NSS1150 containing different dosages of nanosilicate platelets;

FIG. 3 is a plot illustrating relation between the dosage of the nanosilicate platelets and the death rate of algae after the treating agent (NSS1150) is added for 30 minutes;

FIG. 4 is a plot illustrating relation between the dosage of the nanosilicate platelets and the death rate of algae after the treating agent (NSS1150) is added for 12 hours;

FIG. 5 is a plot illustrating concentration variations of algae cells in an eutrophic water body with time, the eutrophic water body being treated with a treating agent of NSS1450S containing different dosages of nanosilicate platelets;

FIG. 6 is a plot illustrating survival ratio variations of algae cells in the eutrophic water body with time, the eutrophic water body being treated with the treating agent of NSS1450S containing different dosages of nanosilicate platelets;

FIG. 7 is a plot illustrating relation between the dosage of the nanosilicate platelets and the death rate of algae after the treating agent (NSS1450S) is added for 30 minutes;

FIG. 8 is a plot illustrating relation between the dosage of the nanosilicate platelets and the death rate of algae after the treating agent (NSS1450S) is added for 12 hours; and

FIG. 9 is a plot illustrating variations of turbidity in an eutrophic water body with time, the eutrophic water body being treated with the treating agent containing different dosages of the nanosilicate platelets.

### DETAILED DESCRIPTION OF THE PREFERRED EMBODIMENTS

Amethod for mitigating eutrophication in a water body according to this invention is conducted by mixing a treating agent that contains nanosilicate platelets (NSP) with an eutrophic water body. The nanosilicate platelets will adsorb algae and suspended substances in the eutrophic water body, and will function to kill the algae and reduce turbidity of the water body.

For clarity, as used herein, the term “eutrophic water body” is a water body that contains a concentration of algae cells ranging from 10⁴ cells/ml to 10⁷ cells/ml, or that has a Carlson's Trophic State Index (CTSI) value greater than 50.

The treating agent is in the form of an aqueous solution or powder, and is preferably in the form of the aqueous solution.

The nanosilicate platelets in the treating agent have an average size of not greater than 500 nm×500 nm for the lateral dimension and 2 nm in thickness, a specific surface area ranging from 500 m²/gram to 800 m²/gram, and a charge density of not less than 10,000 ions/platelet.

The nanosilicate platelets have positive polarity surfaces. The pH value of the treating agent should be controlled to range between 7 to 11 so as to ensure the charge density of the nanosilicate platelets is not less than 10000 ions/platelet. Accordingly, the nanosilicate platelets having positive charges can strongly adsorb algae and suspended substances that have negative polarity surfaces in the eutrophic water body, and can further kill the algae, thereby reducing turbidity of the water body.

Specifically, when the algae are adsorbed and fixed on the surfaces of the nanosilicate platelets, operations of electron transport chains on cell membranes of the algae may be blocked by the positive charges on the nanosilicate platelets. Therefore, the electron transport chains cannot efficiently generate chemical energy for conducting various biochemical reactions in the algae cells. Accordingly, the nanosilicate platelets may be used to inhibit growth of the algae and to cause death of the algae. If the nanosilicate platelets with high-salinity surfaces (e.g., surfaces containing salt-polymer) are used to adsorb the algae, surfaces of the adsorbed algae will be in hypertonicity condition that results in loss of water in the algae cells and causes death of the algae.

The treating agent is prepared by the following steps:

(a) Preparing a Clay Slurry

A layered inorganic clay is dispersed in 1 liter of hot water (60˜90° C.), and then vigorously stirred for 2˜4 hours so as to perform a water swelling treatment, thereby obtaining a well-dispersed clay slurry.

The layered inorganic clay is selected from montmorillonite (MMT), kaolin, mica, talcum, vermiculite, palygorskite, and combinations thereof.

The cation exchange equivalent (CEC) of the layered inorganic clay ranges from 0.5 meq/g to 2.0 meq/g, and preferably ranges from 1.0 meq/g to 1.5 meq/g.

For example, the Bentonite clay, montmorillonite, may be in sodium form (Na⁺-MT) that has cation-exchange capacity and that is available from Nanocor Ind. Co. (trade name: Kuinpia F, CEC=1.15 meq/g).

Mica maybe synthetic fluorinated mica available from CO-OPChemical Co., LTD, Japan (trade name: SOMASIFME-100, CEC=1.20 meq/g).

(b) Preparing an Emulsion

An intercalating agent is mixing with a mineral acid at 80° C. to conduct an acidifying treatment to terminal amino groups of the intercalating agent for 30˜60minutes so as to obtain an emulsion.

The intercalating agent is a straight-chain type polymer product that is prepared by polymerization of polyoxyalkylene amine, p-cresol and formaldehyde, and that is referred to as Amine-termination Mannich Oligomer (AMO).

The molecular weight of the polyoxyalkylene amine ranges from 200 to 10000, and preferably ranges from 1000 to 5000. The polyoxyalkylene amine is selected from polyoxypropylenediamine, polyoxyethylenediamine, and poly(oxyethylene-oxypropylene)diamine, and preferably is polyoxypropylenediamine.

Specifically, examples of the polyoxyalkylene amine include Jeffamine® series products commercially available from Huntsman Chemical Co., such as D-2000, D-4000, T-403, T-5000, T-3000, etc. Jeffamine® D-2000 is a preferable example for the polyoxyalkylene amine and is poly(propylene glycol)bis(2-aminopropyl ether) having a molecular weight of about 2000.

The AMO is represented by the following chemical formula (I). The acidified AMO has terminal amino groups carrying quaternary ammonium cation salts.

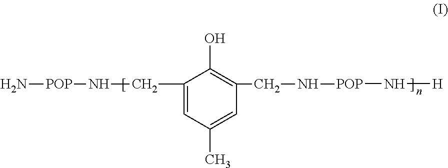

In the above formula (I), n is an integer ranging from 1 to 69, and POP is a divalent moiety and is represented by the following chemical formula (II).

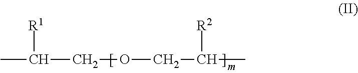

In the above formula (II), each of R¹ and R² is a C₁-C₄ alkyl group, and m is an integer ranging from 10 to 100.

Besides, the mineral acid is selected from hydrochloric acid, sulfuric acid, phosphoric acid and nitric acid.

(c) Conducting an Intercalation Reaction

The clay slurry prepared instep (a) and the emulsion prepared in step (b) are vigorously stirred at a .temperature ranging from 80° C. to 90° C. for 5˜8 hours, so that the intercalating agent is intercalated in the layered inorganic clay through a cation exchange reaction to obtain a layered modified clay that is lipophilic and that has an interlayer spacing ranging from 20 Å to 98 Å. That is, the layers of the layered modified clay are in the crystalline form and are spaced apart by a constant distance.

(d) Conducting an Exfoliation Reaction

This step is conducted by controlling moles of the intercalating agent, and a ratio of moles of the mineral acid to an ion exchange capacity of the layered inorganic clay, thereby increasing the interlayer spacing of the layered modified clay to obtain an exfoliated clay. At this time, the interlayer spacing between the layers of the exfoliated clay is not a constant value, and each layer in the exfoliated clay is dispersed randomly in all directions. The details are also disclosed in U.S. Pat. Nos. 7125916, 7495043, and U.S. Pat. No. 7,442,728.

(e) Displacing the Acidified Intercalating Agent from the Exfoliated Clay

A displacing agent is mixed with the solution obtained in step (d) and vigorously stirred at a temperature ranging from 80° C. to 90° C. for 3˜5 hours to displace the acidified intercalating agent from the exfoliated clay so as to forma solution containing nanosilicate platelets in random state.

The displacing agent is selected from alkali metal hydroxide, alkali metal chloride, alkaline-earth metal hydroxide, and alkaline-earth metal chloride. The displacing agent is preferably sodium hydroxide, potassium hydroxide, lithium chloride, and combinations thereof, and is more preferably sodium hydroxide.

(f) Extraction

Ethanol, water and organic solvent (such as toluene) are added in the solution containing the nanosilicate platelets obtained from step (e), followed by evenly mixing. After partition, the upper layer is the organic solvent layer including the acidified intercalating agent, the middle layer is ethanol layer, and the lower layer is water solution containing the nanosilicate platelets.

The water solution containing the nanosilicate platelets obtained from step (f) can serve as the treating agent of this invention. Otherwise, an additional step (step (g)) may be conducted to organically modify the nanosilicate platelets.

(g) Organically Modifying the Nanosilicate Platelets

An organic surfactant is dissolved in water in an adequate concentration, followed by acidification so as to obtain an acidified organic surfactant solution. Then, the water solution of the nanosilicate platelets obtained from step (f) is added into the acidified organic surfactant solution so as to perform a complexation reaction between the nanosilicate platelets and the organic surfactant, thereby obtaining a homogenous solution including the nanosilicate platelets that are modified to have lipophilic terminal groups. The homogenous solution or powder obtained by subjecting the homogenous solution to a drying process can serve as the treating agent of this invention.

The organic surfactant may be an anion type, a cation type, or a non-ion type organic surfactant.

The anion type organic surfactant is alkylsulfonate, for example, sodium dodecyl sulfate (SDS).

The non-ion type organic surfactant may be selected from octylphenol polyethoxylate, polyoxyethylene alkyl ether, alkylphenol ethoxylate, etc.

The cation' type organic surfactant may be a C₁₂˜C₃₂-fatty amine quaternary ammonium salt, or a C₁₂˜C₃₂-fatty amine hydrochloride quaternary ammonium salt. Examples of the cation type organic surfactant include hexadecyl trimethyl ammonium (HDTMA), dodecyl trimethyl ammonium (DDTMA) , octadecyl ammonium chloride, C₁₈-fatty amine, alkyl dimethyl benzyl ammonium chloride, etc.

The present invention will now be explained in more detail below by way of the following examples. It should be noted that the examples are only for illustration and not for limiting the scope of the present invention.

### EXAMPLE

[Water analysis of Chung-Hsing Lake in National Chung Hsing University]

Inthisinvention,aneutrophicwaterbodywasprepared using the water from Chung-Hsing Lake, and the water analysis results of Chung-Hsing Lake are listed in Table 1.

TABLE 1

| Total | Total | | | | |
|---|---|---|---|---|---|
| phosphorus | nitrogen | Cl⁻ | S0₄²⁻ | Cell Conc. | Turbidity |
| (ppm) | (ppm) | (ppm) | (ppm) | (cells/ml) | (NTU) |
| 0.74 | 1.06 | 10.95 | 49.85 | 3.0 × 10⁶ | 330 |

*Cell conc. means a concentration of algae cells in the water body.

The items for water analysis listed in Table 1 were analyzed by the following procedures:

1. Analysis of Total Phosphorus Concentration

50 ml of the water body was subjected to filtration and digestion treatments so that the phosphorus existing in various forms is coverted to orthophosphoric acid. Thereafter, a vanadate-molybdate reagent was added to react with orthophosphoric acid to obtain a yellow complex. Absorbance of the yellow complex was determined at 420 nm using a spectrophotometer (Spectronic 20 GENESYS spectrophotometer, Beverly, Mass., USA), thereby calculating the amount of total phosphorus.

2. Analysis of total nitrogen concentrations (including NO₂⁻, NO₃⁻and NH₄⁺), and ion concentrations of Cl—, and SO₄²⁻

The ion concentrations were measured using ion chromatography (PX-100, Dionex corp., Sunnyvale, Calif., USA).

3. Concentration of Algae Cells

A predetermined volume of the water body was dropped on a hemocytometer using a pipette, followed by covering with a cover slip. After ensuring no air bubble remained and standing for 10 minutes, the number of algae cells in a determined area (cm³=ml) on the hemocytometer was counted using a microscope so as to calculate the concentration (cells/ml) of algae cells in the eutrophic water body.

4. Turbidity

The turbidity of the water body was measured using a turbidimeter (Hach 2100N, Loveland, Colo., USA).

[Preparation of Eutrophic Water Body)

1. Preparation of a Medium

The water from Chung-Hsing Lake was filtered twice using 20˜25 μm filter (Grade no. 41 qualitative filter paper), and was then filtered using 8pm filter (Grade no. 40 qualitative filter paper), follwed by filtering using 0.22 μm filter (filter paper, Advantec, Dublin, Calif., USA) to obtain a medium. The medium was stored in a refrigerator for ready use.

2. Preparation of Eutrophic Water Body

The medium was poured into a flask (1 liter) , subjected to sterilization in an autoclave (121° C., 1.2 Kg/cm², 20 minutes), and moved to a sterile hood which was sterilized using UV light for 30 minutes. After the medium was cooled to room temperature, a mother liquor of Microcystis sp. was added in the medium, and the flask was sealed by a sterilized rubber stopper. Microcystis sp. in the sealed flask was cultured at 25° C. under shaking and supplied with adequate brightness for 12 hours per day. The culture period may be three or four weeks based on the actual growth of Microcystis sp. Thereafter, a liquor of Microcystis sp. was obtained.

Next, the liquor of Microcystis sp. was adjusted to have a cell concentration (3.0x10⁶ cells/ml) which is the same as that of Chung-Hsing Lake. The adjusted liquor was served as an eutrophic water body, and was poured into eight centrifuge tubes (volume: 50 ml), each of the centrifuge tubes having 10 ml of the adjusted liquor.

### [Preparation of a Treating Agent]

The detail procedures for preparing nanosilicate platelets in a treating agent can also reference to U.S. Pat. nos. 7,12,5916, 7,495,043, and U.S. Pat. No. 7,442,728.

(1) 10 g of Na⁺-montmorillonite (Na⁺-MMT) was dispersed in hot water (1 L, 80° C.) and then vigorously stirred for 4 hours to obtain a stable earth-colored clay slurry, in which Na⁺-MMT was water-swollen.

(2) 57.5 g ofAmine-termination Mannich Oligomer (AMO) was dissolved in water, and mixed with concentrated hydrochloric acid (37 wt % , 1.2 g) and deionized water (5 g) at 80° C. for 30 minutes to acidify AMO.

(3) The acidified AMO and the clay slurry containing water-swollen Na⁺-MMT were vigorously stirred at 80° C. for 5 hours, thereby conducting intercalation and exfoliation reactions to obtain a light yellow slurry emulsion. In the slurry emulsion, Na⁺-MMT was modified and exfoliated by acidified AMO, and was formed into a exfoliated clay.

(4) The light yellow slurry emulsion was evenly mixed with 30 ml of ethanol and NaOH (10 wt %, 3.7 g, one time equivalent) to perform a first cation exchange reaction, followed by filtration to obtain a light yellow and semi-transparent solid. Thereafter, the solid was evenly mixed with 30 ml of ethanol and NaOH (10 wt %, 3.7 g, one time equivalent) to obtain a mixture solution, followed by performing a second cation exchange reaction. After the second cation exchange reaction, the acidified AMO on surfaces of the exfoliated clay was fully displaced by Na⁺ so as to obtain Na⁺ nanosilicate platelets (Na⁺-NSP) in the mixture solution.

(5) 30 ml of toluene was evenly mixed with the mixture solution. After partition, three layers were obtained, in which an upper layer includes the acidified AMO and toluene, the middle layer is ethanol, and the lower layer is Na⁺-NSP water solution (i.e., a water solution including Na⁺-NSP). The upper and middle layers were removed.

(6) 840 g of alkyl (C18) fatty amine was dispersed in 7.56 liters of deionized water and evenly stirred at 80° C. to obtain a fatty amine solution, followed by slowly and dropwise adding with HCl (10 wt %, 1134 g) to perform an acidifying treatment. The fatty amine solution was stirred for about one hour until the solution became semi-transparent.

(7) The Na⁺-NSP water solution (10 wt %, 8.4 L) obtained in step (5) was well mixed with the solution obtained in step (6) to perform a cation exchange reaction between Na⁺-NSP and fatty amine for about one hour. In this step, Na⁺-NSP was organically modified by fatty amine, thereby obtaining a treating agent of NSS1150 (NSP and fatty amine in water at 10 wt %)

2. NSS1450S

The process for preparing a treating agent of NSS1450S was similar to that for preparing the treating agent of NSS1150, except that, in preparing the treating agent of NSS1450S, Na⁺-NSP was organically modified using alkyl dimethyl benzyl ammonium chloride to obtain the treating agent of NSS1450S (10 wt %) . The alkyl groups in alkyl dimethyl benzyl ammonium chloride include C₁₂ alkyl group, C₁₄ alkyl group, and C₁₆ alkyl group at a ratio of 63: 30: 7.

### Examples 1˜6 and Comparative Examples 1˜2

5 ml of each of the treating agents (10 wt %), i.e., NSS1150 and NSS1450S, was diluted with 5 ml of deionized water so as to obtain a diluted treating agent (5 wt %).

In each of Examples 1˜6 (EX 1˜6) and Comparative Examples 1˜2 (CE 1˜2) , the treating agent (5 wt % or 10 wt %) was added in the eutrophic water body in the centrifuge tube obtained in the preceding section entitled “Preparation of eutrophic water body” in a sterile hood, followed by shaking at an appropriate frequency using a shaker. The amount of the treating agent and the dosage of Na⁺-NSP contained in the treating agent in each of the examples and comparative examples are listed in Table 2.

TABLE 2

| | | EX | | | | | | | CE |
|---|---|---|---|---|---|---|---|---|---|
| | | 1 | EX 2 | EX 3 | CE 1 | EX 4 | EX 5 | EX 6 | 2 |
| NSS1150 | 5 wt % | 20 | | | | | | | |
| (μl) | 10 wt % | | 20 | 100 | | | | | |
| NSS1450S | 5 wt % | | | | | 20 | | | |
| (μl) | 10 wt % | | | | | | 20 | 100 | |

| | | | | | | | | |
|---|---|---|---|---|---|---|---|---|
| Eutrophic water | 10 | 10 | 10 | 10 | 10 | 10 | 10 | 10 |
| body (ml) | | | | | | | | |
| Na⁺-NSP dosage | 10 | 100 | 500 | — | 10 | 100 | 500 | — |
| (ppm) | | | | | | | | |

### Examples 7˜11 and Comparative Example 3

10 wt % of the treating agent, i.e., NSS1450S, was diluted with deionized water so as to obtain a diluted treating agent with a concentration of 5 wt % or 1 wt %. Different amounts of diluted treating agent, NSS1450S, were added into 300 ml of the eutrophic water body obtained in the preceding section entitled “Preparation of eutrophic water body”, were sequentially stirred at 120 rpm for 1 minute and at 20 rpm for 20 minutes, and were allowed to stand. The amount of the treating agent and the dosage of Na⁺-NSP contained in the treating agent in each of the examples 7-11 and comparative example 3 are listed in Table 3.

TABLE 3

| | | EX 7 | EX 8 | EX 9 | EX 10 | EX 11 | CE 3 |
|---|---|---|---|---|---|---|---|
| NSS1450S | 1 wt % | 0.3 | 0.6 | | | | |
| (ml) | 5 wt % | | | 0.3 | 0.6 | 3 | |

| | | | | | | |
|---|---|---|---|---|---|---|
| Eutrophic water | 300 | 300 | 300 | 300 | 300 | 300 |
| body (ml) | | | | | | |
| Na⁺-NSP dosage | 10 | 20 | 50 | 100 | 500 | — |
| (ppm) | | | | | | |

### [Evaluations]

1. Effect of Nanosilicate Platelets on Killing Algae

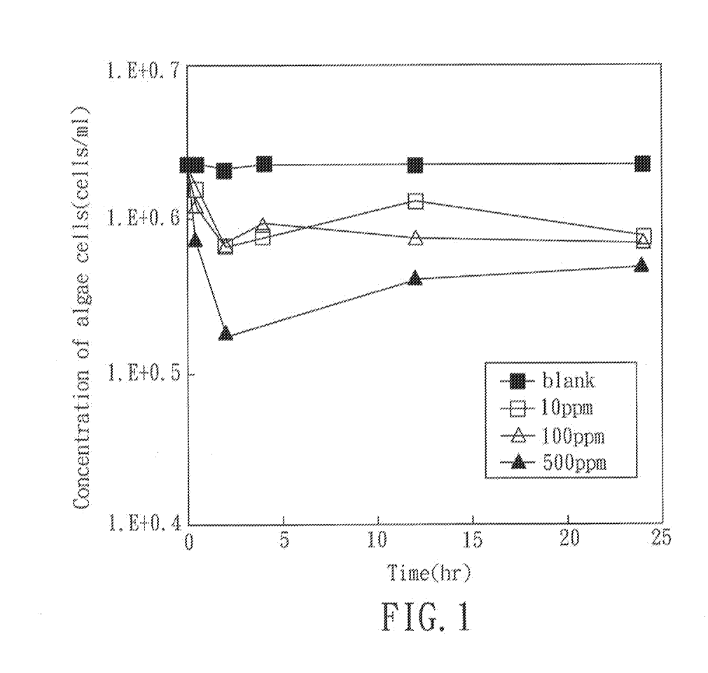

In each of EX 1-6 and CE 1-2, the eutrophic water body was sampled at different time points (0 hr, 0.5 hr, 2 hrs, 4hrs, 12 hrs and 24hrs after addition with the treating agent and analyzed using a hemocytometer. The sampling and analysis were conducted three times for each of the examples and the comparative examples. Relations among the time treated with the treating agent, the dosage of Na⁺-NSP, and killing effect for algae that is represented by death rate or survival ratio) are shown in FIGS. 1 to 8.

2. Effect of Nanosilicate Platelets on on Turbidity Reduction

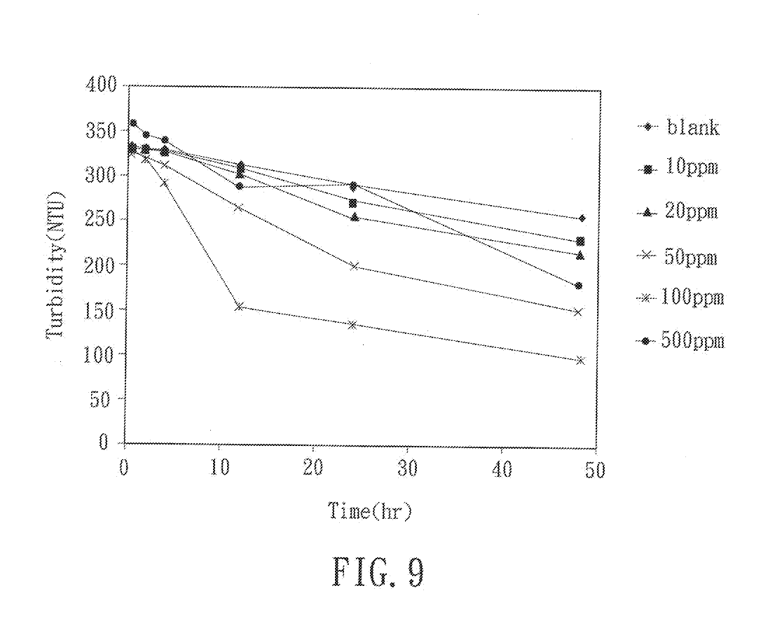

In each of EX 7˜11 and CE 3, after the eutrophic water bodywas left standing for 0.5 hr, 2 hrs, 4 hrs, 12 hrs, 24 hrs and 48 hrs, the turbidity of the eutrophic water body was measured. The results are shown in Table 4 and FIG. 9.

TABLE 4

| | Standing | | | | | | |
|---|---|---|---|---|---|---|---|
| | time (hr) | EX 7 | EX 8 | EX 9 | EX 10 | EX 11 | CE 3 |
| Turbidity | 0.5 | 327 | 329 | 324 | 328 | 359 | 332 |
| (NTU) | 2 | 328 | 329 | 321 | 319 | 345 | 330 |
| | 4 | 326 | 327 | 312 | 292 | 338 | 329 |
| | 12 | 309 | 302 | 263 | 154 | 289 | 313 |
| | 24 | 274 | 254 | 200 | 136 | 292 | 290 |
| | 48 | 232 | 218 | 153 | 101 | 181 | 258 |

### [Result Analysis]

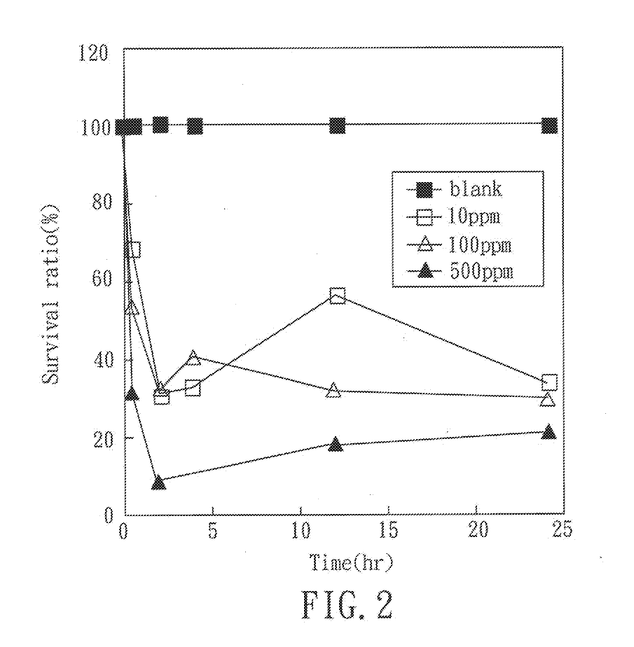

FIGS. 1 and 2 illustrate effect of the treating agent (NSS1150) on killing algae in the eutrophic water body (i.e., the results of EX 1˜3 and CE 1). It is found that, when the dosages of Na⁺-NSP are 10 ppm, 100 ppm and 500 ppmi death rates of the algae may reach 68.7%, 67.5% and 92.6%, respectively, at 2 hour after the treating agent (NSS1150) was added.

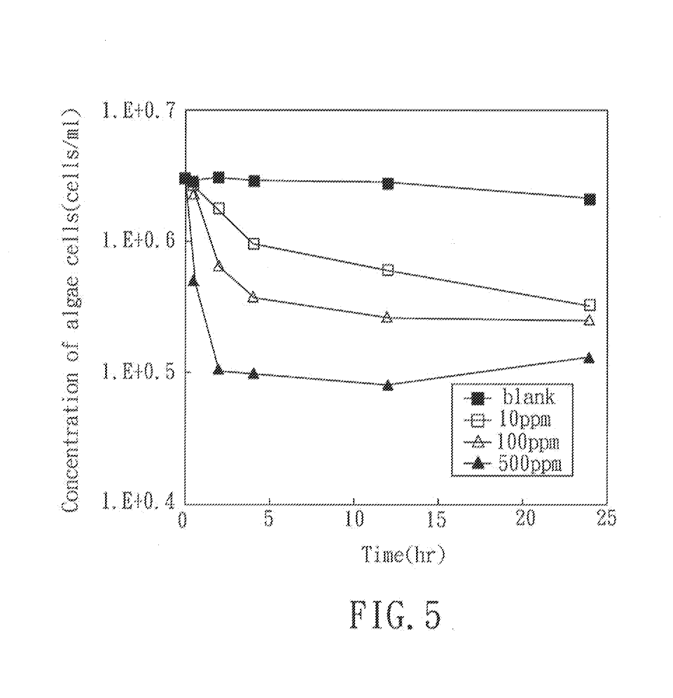

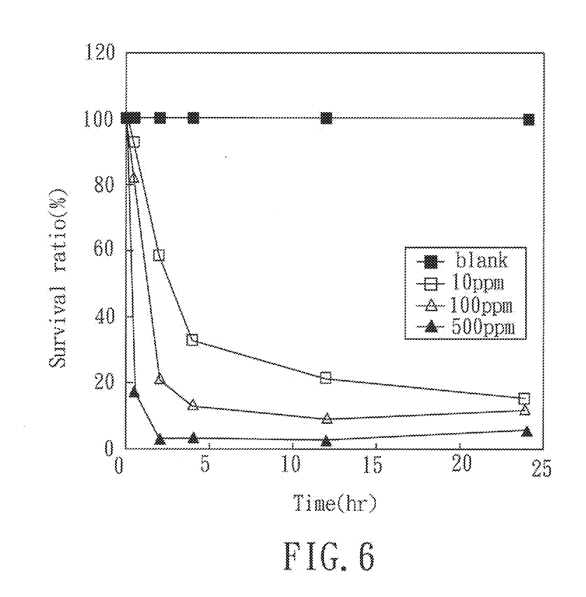

FIGS. 5 and 6 illustrate effect of the treating agent (NSS1450S) on killing algae in the eutrophic water body (i.e., the results of EX 4˜6 and CE 2). It is found that, when the dosage of Na⁺-NSP is 10 ppm, the death rate ranges from about 41.2% (at 2 hour after addition of NSS1450S) to 66.7% (at 4 hour after addition of NSS1450S), and the death rate may reach 85% at 24 hour after addition of NSS1450S. When the dosages of Na⁺-NSP are 100 ppm and 500 ppm, death rates of the algae may reach 86.6% and 96.6%, respectively, at 4 hour after addition of the treating agent (NSS1450S).

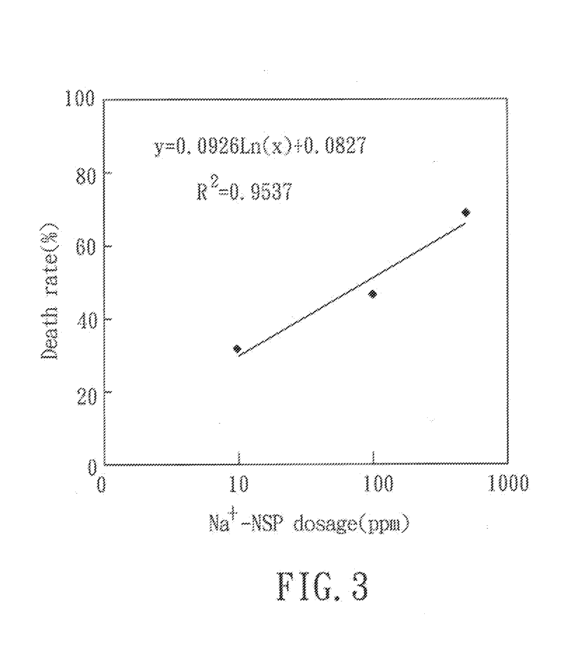

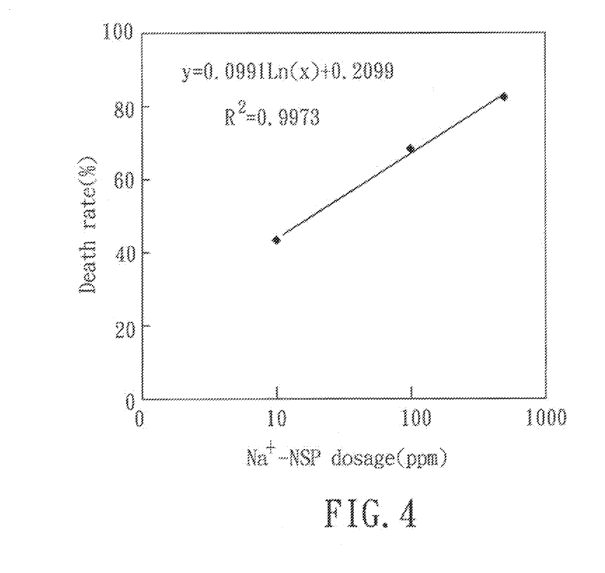

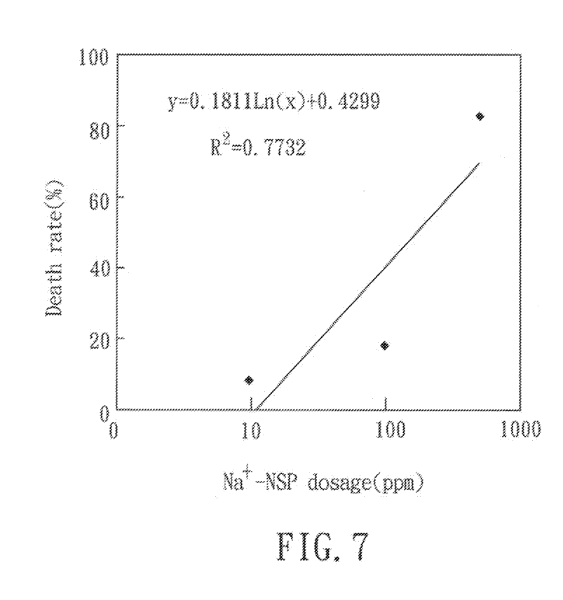

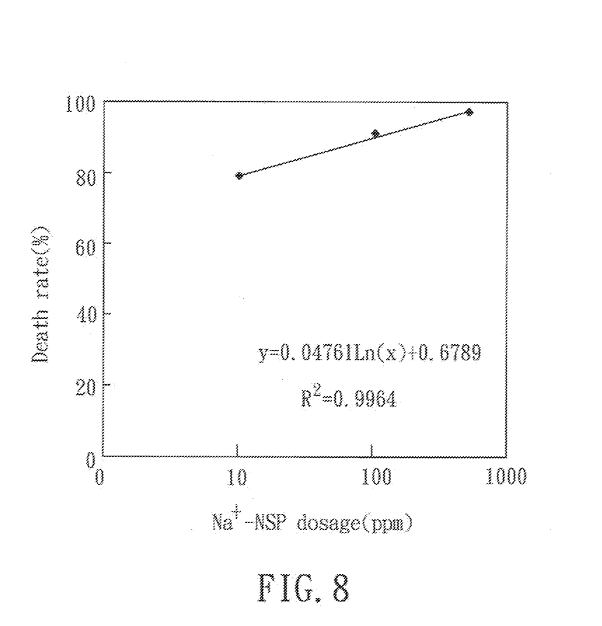

FIGS. 3, 4, 7 and 8 illustrate regression analysis results, which show logarithmic relation between death rates and Na⁺-NSP dosage at 0.5 hour and 12 hour after the treating agents (NSS1150, NSS1450S) are added. That is, when Na⁺-NSP dosage is greater than a threshold value, the increase in algae killing effect ofNa⁺-NSP is limited . From FIG. 3, it may be estimated that, a lethal concentration (LC50) that kills 50% of the algae (Microcystis sp.) is 90 ppm at 0 . 5 hour after the treating agent (NSS1150) was added. From FIG. 4, at 12 hour after the treating agent (NSS1150) was added, the LC50 is 18.7 ppm. From FIG. 7, at 0.5 hour after the treating agent (NSS1450S) was added, the LC50 is 143 ppm. From FIG. 8, at 12 hour after the treating agent (NSS1450S) was added, the LC50 is 0.024 ppm. Accordingly, the treating agent (NSS1150) has better algae killing effect at an initial period, and the treating agent (NSS1450S) has better algae killing effect at a later period.

In summary, the treating agent (NSS1150, NSS1450S) containing nanosilicate platelets can effectively kill algae (Microcystis sp.) and inhibit the growth of algae after adding the treating agent for several hours. Although the algae killing effect may be relatively weak at the later period, the treating agents, especially NSS1450S, can still effectively kill algae.

On the other hand, as shown in Table 4 and FIG. 9, at 24 hour after treatment with the treating agent, the turbidity of the eutrophic water body can be efficiently reduced. Especially in EX 10, when Na⁺-NSP dosage is 100 ppm, the turbidity can be reduced to 136 NTU at 24 hour, and reduced to 101 NTU at 48 hour. Accordingly, the treating agent of this invention can efficiently reduce the turbidity of the eutrophic water body.

Because the nanosilicate platelets have relatively high surface areas and charge density, the treating agent of this invention that includes the nanosilicate platelets are capable of adsorbing algae and suspended substances in the eutrophic water body to quickly remove the algae and reduce the turbidity in the eutrophic water body. Besides, use of the treating agent of this invention will not cause environmental problems, and thus, the treating agent has a potential for use in in situ remediation of water reservoirs.

While the present invention has been described in connection with what are considered the most practical and preferred embodiments, it is understood that this invention is not limited to the disclosed embodiments’ but is intended to cover various arrangements included within the spirit and scope of the broadest interpretations and equivalent arrangements.

What is claimed is:

1. Amethod for mitigating eutrophication in a water body, comprising: adding a treating agent that contains nanosilicate platelets to an eutrophic water body, such that algae and suspended substances in the eutrophic water body are adsorbed by the nanosilicate platelets.

2. The method of claim 1, wherein the nanosilicate platelets have positive polarity surfaces.

3. The method of claim 1, wherein the treating agent is in the form of an aqueous solution or powder.

4. The method of claim 1, further comprising preparing the treating agent that includes the following steps of:
acidifying an intercalating agent;
reacting a layered inorganic clay with the acidified intercalating agent to obtain an exfoliated clay; and
reacting the exfoliated clay with a displacing agent for displacing the acidified intercalating agent in the exfoliated clay, the displacing agent being selected from the group consisting of alkali metal hydroxide, alkali metal chloride, alkaline-earth metal hydroxide, and alkaline-earth metal chloride.

5. The method of claim 4, further comprising:
preparing the intercalating agent by reacting polyoxyalkylene amine, p-cresol and formaldehyde.

6. The method of claim 4, wherein the layered inorganic clay is selected from the group consisting of montmorillonite (MMT), kaolin, mica, talcum, vermiculite, palygorskite, and combinations thereof.

7. The method of claim 4, wherein the displacing agent is selected from the group consisting of sodium hydroxide, potassium hydroxide, lithium chloride, and combinations thereof.

8. The method of claim 5, wherein the polyoxyalkylene amine is selected from the group consisting of polyoxypropylenediamine, polyoxyethylenediamine, and poly(oxyethylene-oxypropylene)diamine.

9. The method of claim 1, wherein the nanosilicate platelets have an average size of not greater than 500 nm×500 nm for the lateral dimension and 2 nm in thickness, a specific surface area ranging from 500 m²/gram to 800 m²/gram, and a charge density of not less than 10000 ions/platelet.
